(19) United States
(12) Patent Application Publication
(10) Pub. No.: US 2025/0058657 A1
(43) Pub. Date: Feb. 20, 2025

(54) RAPID CHARGING SYSTEM

(71) Applicant: SCHUNK TRANSIT SYSTEMS GMBH, Wettenberg (DE)

(72) Inventor: Oliver Borchardt, Giessen (DE)

(21) Appl. No.: 18/578,486

(22) PCT Filed: Jul. 12, 2021
(86) PCT No.: PCT/EP2021/069339

§ 371 Date: Jan. 11, 2024

(51) Int. Cl. B60L 53/10; B60L 53/16; B60L 53/35

(52) U.S. Cl. CPC B60L 53/11; B60L 53/16; B60L 53/35

(57) ABSTRACT

The invention relates to a rapid-charging system (10) for electrically driven vehicles, in particular passenger cars, trucks, busses or the like, the rapid-charging system comprising a contact device (11), a charging contact device (12) and a positioning device (13), the charging contact device being disposable on or in a vehicle bottom (14) of a vehicle and comprising a charging contact support (17) having charging contacts, the contact device being disposable on or at least partially in a ground (15) under the vehicle on which the vehicle can drive and comprising a contact support (16) having contacts, wherein each contact can establish contact with a charging contact to form a contact pairing, wherein the contact support can be positioned relative to the charging contact support in a contact position by means of the positioning device in such a manner that an electrically conductive connection between the vehicle and a stationary charging station can be realized, wherein the contact support has a projection (18) having the contacts disposed thereon and the charging contact support has an opening (19) having the charging contacts disposed thereon, or vice versa, the projection and the opening having respective contact surfaces (20, 21) of a matching geometric shape, a contour (25) of the projection being oval.

The invention relates to a rapid-charging system for electrically driven vehicles and to a vehicle having a rapid-charging system of this kind, in particular a passenger car, truck, bus or the like, the rapid-charging system comprising a contact device, a charging contact device and a positioning device, the charging contact device being disposable on or in a vehicle bottom of a vehicle and comprising a charging contact support having charging contacts, the contact device being disposable on or at least partially in a ground under the vehicle on which the vehicle can drive and comprising a contact support having contacts, wherein each contact can establish contact with a charging contact to form a contact pairing, wherein the contact support can be positioned relative to the charging contact support in a contact position by means of the positioning device in such a manner that an electrically conductive connection between the vehicle and a stationary charging station can be realized.

Rapid-charging systems of this kind are known from the state of the art and are commonly employed for charging electrically driven vehicles at a stopping place, for example. In this case, a distinction is made between rapid-charging systems which are disposed on a roof of a vehicle or under a bottom of a vehicle.

Charging systems can also consist of a plug-socket connection, wherein in this case, however, only low currents can be transmitted, which extends a charging time. Furthermore, often a manual coupling of the plug and the socket by an operator is required and special requirements for the electrical safety to protect persons have to be observed, which is not the case with automated rapid-charging systems beyond reach of persons. Therefore, it seems reasonable to dispose rapid-charging systems under vehicles, such as passenger cars, trucks or busses, since, in this case, particularly high currents, for example 500 A to 1000 A with a voltage of up to 750 V, can be transmitted. In the known rapid-charging systems, the contact device is typically mounted on a ground under the vehicle or disposed in a pit or a similar type of recess in the ground.

For instance, rapid-charging systems are known in which a matching contact device establishes contact with a charging contact device disposed under a vehicle bottom. In this case, a contact support is guided into a contact position by means of a positioning device of the rapid-charging system, contacts in the contact position establishing contact with charging contacts on the charging contact device to form an electrically conductive connection. In this process, contact pairings for a charging circuit and for, for example, a control line, grounding or a data transmission are formed. Therefore, the intention always is for contact to be established between a plurality of contacts and respectively assigned charging contacts. A rapid-charging system of this kind is known from DE 10 2009 001 080 A1, for example.

When a contact device and a charging contact device are being joined by means of the positioning device, the problem always arises that, in order to produce contact pairings, the contact device and/or the contacts have to be brought into the position provided for this purpose relative to the charging contacts of the charging contact device. If the vehicle is positioned above the contact device by a vehicle user or an automated control of the vehicle, a horizontal position of the charging contact device however always differs from a position of the contact device such that a position correction is required when the contact device and the charging contact device are being joined by means of the positioning device. This position correction can be carried out by the positioning device itself and often requires a complex control and a sensor technology for the position detection. At the same time, in particular since a process of establishing contact is to be carried out as quickly as possible, no exact relative positioning of the contact device and the charging contact device is possible with a control of this kind. In particular on contact surfaces of the contact device and the charging contact device, therefore, often an undesirable wear or damages occur(s) over a longer service life as a result of the processes of establishing contact.

The object of the invention at hand is therefore to propose a rapid-charging system which allows to securely and quickly establish contact also in the case of a longer use.

This object is attained by a rapid-charging system having the features of claim 1 and a vehicle having the features of claim 18.

In the a rapid-charging system according to the invention for electrically driven vehicles, in particular passenger cars, trucks, busses or the like, the rapid-charging system comprises a contact device, a charging contact device and a positioning device, the charging contact device being disposable on or in a vehicle bottom of a vehicle and comprising a charging contact support having charging contacts, the contact device being disposable on or at least partially in a ground under the vehicle on which the vehicle can drive and comprising a contact support having contacts, wherein each contact can establish contact with a charging contact to form a contact pairing, wherein the contact support can be positioned relative to the charging contact support in a contact position by means of the positioning device in such a manner that an electrically conductive connection between the vehicle and a stationary charging station can be realized, wherein the contact support has a projection having the contacts disposed thereon and the charging contact support has an opening having the charging contacts disposed thereon, or vice versa, wherein the contact support has an opening having the contacts disposed thereon and the charging contact support has a projection having the charging contacts disposed thereon, the projection and the opening having respective contact surfaces of a matching geometric shape, a contour of the projection being oval.

The rapid-charging system according to the invention thus has the projection and the opening which fit into each other such that, when the projection and the opening are disposed in the correct position relative to each other, the contacts and the charging contacts are also disposed in the correct position relative to each other. The projection can be realized on the contact support or on the charging contact support and the opening can be realized on the charging contact support or on the contact support. The respective contact surfaces of the projection and the opening which come into contact with each other in the contact position have at least sectionally a matching geometric shape which allows to position the charging contact support and the contact support securely and in the correct position. The contour of the projection, i.e. a line running on a circumference of the projection or a line running along the contact surface of the projection, is oval. The contour therefore differs from a circular shape, is noncircular and not angular. Since the contour of the projection is oval, damages or an increased wear are/is effectively avoided when the projection and the opening are being joined. In the case of angular projections, however, contact surfaces can be scratched or damaged when a corner of the projection hits a contact surface of the opening when the contact support and the charging contact support are being joined. Since the contour of the projection is oval, it is furthermore possible to position the contact support and the charging contact support precisely only by means of the geometric shape of the contour. A circular contour would not allow this since, in this case, the contact support can be twisted relative to the charging contact support. Moreover, in this case, the contacts and/or charging contacts would also have to be concentrically designed and disposed. In the case of the rapid-charging system according to the invention, the contacts and the charging contacts can basically be of any geometric shape and be disposed in the area of the projection and/or the opening. On the whole, it, thus, becomes possible to ensure a safe and reliable function of the rapid-charging system by simple means.

In the contact position, the contacts and the charging contacts can be disposed in a contact plane parallel relative to the vehicle bottom and/or the ground. In this case, the projection and the opening can contact each other in the contact plane in the contact position with their respective contact surfaces. Within these contact surfaces, the contacts and/or the charging contacts can be disposed opposite each other. Thus, the rapid-charging system can have particularly large contact surfaces for the transmission of high currents and also a low overall height.

The opening and the projection can contact each other at least in the contact plane with their respective end faces in the contact position. In this case, the end faces can be realized essentially flat and have no further protruding projections or recesses.

The opening and the projection can form respective matching lateral surfaces inclined relative to the contact plane. Since the respective lateral surfaces of the opening and the projection are inclined, the projection can be centered in the opening when the contact support and the charging contact support are being joined by means of the positioning device. The lateral surfaces can slide along each other during the joining process until the contact position is reached. Since the contour of the projection is oval, the lateral surfaces also run in an oval manner with respect to the contact plane such that, in this case, no substantial damage or wear of the projection and/or the opening can occur during the joining process. The inclination of the lateral surface can be comparatively large such that the lateral surfaces can be realized with an obtuse angle with respect to the contact plane.

The contour of the projection can be symmetrical. In contrast to an asymmetrical realization of the contour, thus, an even distribution of forces results in the contact position and, thereby, a secure establishment of contact. Moreover, a symmetrical contour is comparatively easier to produce.

The contour of the projection can have the shape of an ellipse or an arc polygon. The arc polygon can be realized in the manner of a curve of constant width and with strongly rounded corners. An ellipse has a shape which approximates a circle such that a secure contact of the projection and the opening can be achieved and, at the same time, an undesirable twisting can be prevented.

Advantageously, a main axis of the ellipse can be transverse to a driving direction of the vehicle. In principle, it is however also possible to dispose a minor axis of the ellipse in a transverse direction to the driving direction of the vehicle. In this case, the driving direction of the vehicle is understood to be a longitudinal axis of the vehicle.

The contour of the opening can be open on one side relative to the driving direction of the vehicle. In this case, the opening can be realized in the manner of a bay. In principle, joining the projection and the opening in a vertical direction relative to the vehicle and/or the ground is possible. If the opening is open on one side, the projection can also be inserted into the opening in the horizontal direction. In this case, it is also possible to drive with the vehicle toward the contact device and, thus, move the projection and the opening closer together and bring them into the contact position. Furthermore, it is also possible that the positioning device is realized in such a manner that a joining of the projection and the opening by means of the positioning device is carried out in the vertical and the horizontal direction.

The contact support and/or the charging contact support can have springs each exerting a spring force on contacts and/or charging contacts in such a manner that the contact and/or the charging contact in question is pressed in the direction of an opposite contact and/or charging contact. By means of the spring, a spring force can be exerted on the contact and/or the charging contact in such a manner that the contact is pressed in the direction of a charging contact, or vice versa. The contact and/or the charging contact can be spring-mounted by a compression spring, in particular a spiral spring. As a result, thus, a punctual contact or a surface contact of the contact and the charging contact can be formed in the contact position under a spring preload. A spring force can be selected in such a manner that the contact and the charging contact are always pressed in a direction toward the charging contact and the contact, respectively, and moved in a frontal end position when no contact pairing is formed. The contact and the charging contact can be realized in such a manner that a current of 500 A to 1000 A at a voltage of up to 1500 V, preferably 350 A at a voltage of 440 V, can be transmitted in the contact position. Thus, a power of 750 kW to 1500 kW, preferably 150 KW, can be transmitted via the rapid-charging system. In the case of a spring preload, at least two contacts and/or charging contacts can protrude relative to the respective contact surface in different heights. Thus, it is in this case possible to ensure a defined order during the establishment of the contact pairings between respective contacts and charging contacts when at least two contact pairings are formed.

The contacts and the charging contacts can each be realized by printed boards, wherein the printed boards can be disposed within a surface of a contact support element of the contact support and/or a charging contact support element of the charging contact support, said contact support element being made of a dielectric material. For example, the contact support element and/or the charging contact support element can be made of a plastic material. The printed boards can be embedded in the plastic material or protrude a bit beyond the surface of the plastic material. The printed boards can essentially be round, oval or strip-shaped.

The contact support and/or the charging contact support can be at least sectionally rotatable and/or pivotable relative to a vertical central axis of the rapid-charging system. The rotatability and/or pivotability of the contact support and/or the charging contact support allow(s) for a tolerance compensation when the projection is inserted into the opening. A movement of the vehicle can occur also during a charging process, for example due to persons entering or leaving the vehicle, such that a vehicle movement can be compensated for also in this case. In particular, the positioning device can be designed in such a manner that it allows the rotatability and pivotability within limits.

The contact device or the charging contact device can have the positioning device, wherein the positioning device can be realized by at least a pantograph, a pivoted lever, a swing arm or a telescope guide by means of which the contact support or the charging contact support can be positioned in an at least vertical direction. For instance, the positioning device can be disposed and/or realized on the ground or the vehicle. In principle, it is also possible to use a positioning device on the contact device and the charging contact device each. It is essential that the positioning device can move the contact support and/or the charging contact support in the vertical direction. However, depending on the design of the positioning device, a horizontal movement may also be performed simultaneously during the performance of the vertical movement.

The positioning device can also be realized by pivotable arms which are disposed in a star-shaped manner relative to a vertical central axis of the rapid-charging system and on whose respective ends can be disposed a contact or a charging contact. Compared to a telescope guide, a positioning device of this kind can be particularly flat and can be disposed advantageously on a ground or underneath on a vehicle. The arms can be moved by means of a central electric drive and supportively exert a contact force between the projection and the opening by means of springs.

Alternatively, the positioning device can be realized by a level control of the vehicle, wherein the charging contact device can be positioned in an at least vertical direction by means of said level control. The level control can be realized by a chassis of the vehicle supported with air pressure and enable a lowering of the vehicle relative to the ground. The charging contact support can be joined with the contact support by lowering the vehicle. In this case it is particularly advantageous that no special realization of a positioning device is necessary and that the level control of the chassis which is present on the vehicle anyway can be used as positioning device.

The contact device and/or the charging contact device can each have a protective element having at least one movable plate by means of which an end side of the contacts and/or the charging contacts can be completely covered. In this case, an upper side of the contact device and/or an underside of the charging contact device can be covered with the plate made of a dielectric material, for example. The dielectric material of the plate can be a plastic material, for example a fiber-reinforced plastic. In this case, the plate can cover the contact support and/or the charging contact support completely and, thus, prevent the contact support and/or the charging contact support from possibly becoming dirty or damaged when they are not in use.

The contact device can be realized in such a manner that the vehicle can drive on and/or over it. The contact device can be realized in such a manner that it fits between pairs of tires of a vehicle. At the same time, parts of the contact device or alternatively the entire contact device can be realized in such a manner that a vehicle can drive over it in such a manner that the vehicle stands with its wheels on the contact device during a charging process. In this case too, the dimensions of the contact device can be adapted to the vehicle dimensions, for example according to the size of the parking bay.

The contact device and/or the charging contact device can have a transponder unit, wherein the transponder unit can be coupled with the positioning unit and data can be transmitted between the transponder unit and the positioning device. In this case, the transponder unit can be used as a positioning aid for a control of the positioning unit. Thus, in this case, the control of the positioning unit can, for example, detect if the vehicle is located above the contact device and if the charging contact device is moved closer to the contact device in the desired manner. When the contact device and the charging contact device are being joined, the transponder unit can be used to control the joining process. In the contact position, a data exchange can also be carried out, for example for settling a charging process.

The vehicle according to the invention, in particular a passenger car, truck, bus or the like, comprises a rapid-charging system according to the invention. Further advantageous embodiments of a vehicle are provided by the dependent claims referring back to claim 1.

The invention can basically be used for any type of electric vehicles which are powered by batteries which need to be recharged.

Below, preferred embodiments of the invention are explained in more detail with reference to the accompanying drawings.

### IN THE FIGURES

FIG. 1 shows a side view of a first embodiment of a rapid-charging system;

FIG. 2 shows a side view of a second embodiment of a rapid-charging system;

FIG. 3 shows a side view of a third embodiment of a rapid-charging system;

FIG. 4 shows a side view of a fourth embodiment of a rapid-charging system;

FIG. 5 shows a side view of a fifth embodiment of a rapid-charging system;

FIG. 6 shows a side view of a sixth embodiment of a rapid-charging system;

FIG. 7 shows a top view of a seventh embodiment of a rapid-charging system;

FIG. 8 shows a top view of an eighth embodiment of a rapid-charging system;

FIG. 9 shows a top view of a charging contact device of a ninth embodiment of a rapid-charging system;

FIG. 10 shows a top view of a contact device of the rapid-charging system of FIG. 9.

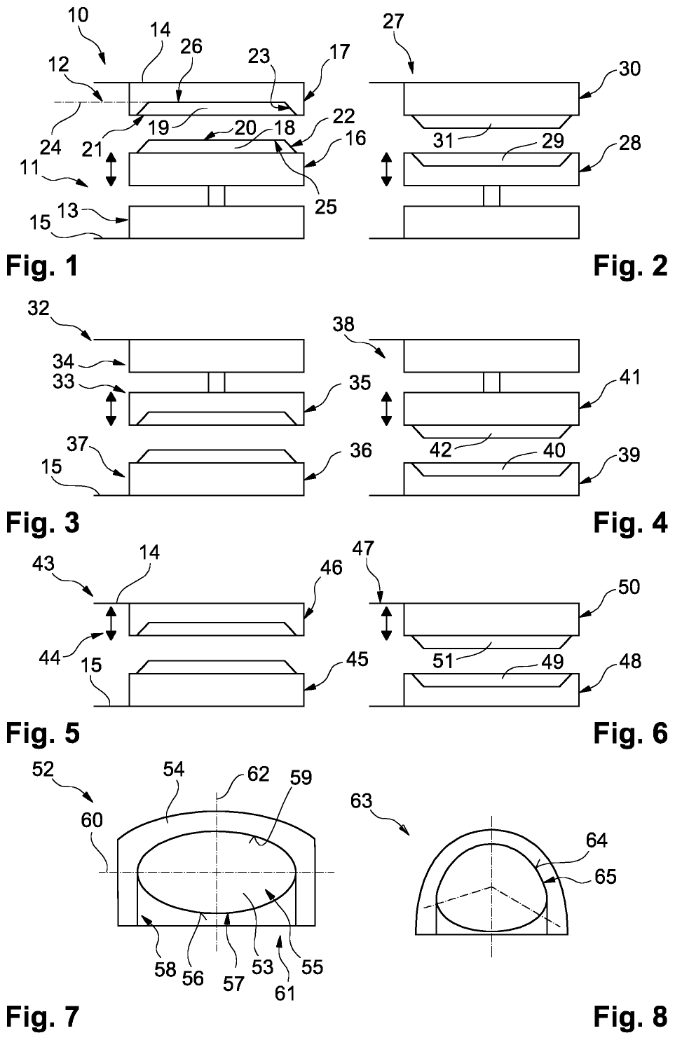

FIG. 1 shows a schematic illustration of a rapid-charging system 10 comprising a contact device 11, a charging contact device 12 and a positioning device 13. Charging contact device 12 is disposed on a vehicle bottom 14 of a vehicle, which is not illustrated in more detail in the case at hand. Under charging contact device 12, positioning device 13 is disposed on a ground 15 on which a vehicle can drive. A contact support 16 of contact device 11 is disposed on positioning device 13, wherein said contact support 16 can be reciprocated in the direction of a charging contact support 17 of charging contact device 12. Thus, contact device 11 comprises in this case contact support 16 and positioning device 13.

Furthermore, a projection 18 is realized on contact support 16, contacts, which are not illustrated in the case at hand, being disposed on said projection 18. An opening 19 is realized on charging contact support 17, charging contacts, which are not illustrated in more detail in the case at hand, being disposed on said opening 19, wherein the contacts can establish electrical contact with said charging contacts. When contact support 16 and charging contact support 17 are being joined, projection 18 is inserted into opening 19 until a contact position is reached in which, then, contact pairings between contacts and charging contacts are formed which allow for a charging of the respective vehicle and/or a battery of the vehicle. In the contact position, a contact surface 20 of projection 18 comes into contact with a contact surface 21 of opening 19. Furthermore, a lateral surface 22 of projection 18 is inclined relative to a contact plane 24 running parallel to vehicle bottom 14 and/or ground 15 and can slide along a lateral side 23 of opening 19 during the joining process such that contact support 16 is centered during the joining process. Opening 19 also has a contour 26 which corresponds sectionally to contour 25. In particular, a contour 25 of projection 18 is oval such that an accurate positioning can be carried out during the joining process.

FIG. 2 shows a rapid-charging system 27 in which, in contrast to the rapid-charging system of FIG. 1, a contact support 28 is realized with an opening 29 and a charging contact support 30 is realized with a projection 31.

FIG. 3 shows a rapid-charging system 32 in which, in contrast to the rapid-charging system of FIG. 1, a charging contact device 33 comprises a positioning device 34 by means of which a charging contact support 35 can be moved. In this case, a contact support 36 on contact device 37 is disposed directly on ground 15.

FIG. 4 shows a rapid-charging system 38 in which, in contrast to the rapid-charging system of FIG. 3, a contact support 39 is realized with an opening 40 and a charging contact support 41 is realized with a projection 42.

FIG. 5 shows a rapid-charging system 43 in which, in contrast to the rapid-charging system of FIG. 1, a vehicle, which is not illustrated in more detail in the case at hand, realizes a positioning device 44. In this case, positioning device 44 is realized by a level control of the vehicle (not shown). In this case, a contact support 45 is disposed directly on ground 15 and a charging contact support 46 is disposed on vehicle bottom 14.

FIG. 6 shows a rapid-charging system 47 in which, in contrast to the rapid-charging system of FIG. 5, a contact support 48 is realized with an opening 49 and a charging contact support 50 is realized with a projection 51.

FIG. 7 shows a simplified top view of a rapid-charging system 32 having a contact support 53 and a charging contact support 54. Contact support 53 is realized with a projection 55 which forms a contour 56 having the shape of an ellipse 57. Charging contact support 54 forms an opening 58 which receives projection 55 and forms a contour 59 which approximates the shape of ellipse 57 on one side along a main axis 60. Therefore, charging contact support 54 is realized in the manner of a bay 61 into which projection 55 can be inserted along a minor axis 62 of ellipse 57.

FIG. 8 shows a comparable view of a rapid-charging system 63, wherein in this case, in contrast to the rapid-charging system illustrated in FIG. 7, a contour 64 is realized in the shape of an arc polygon 65.

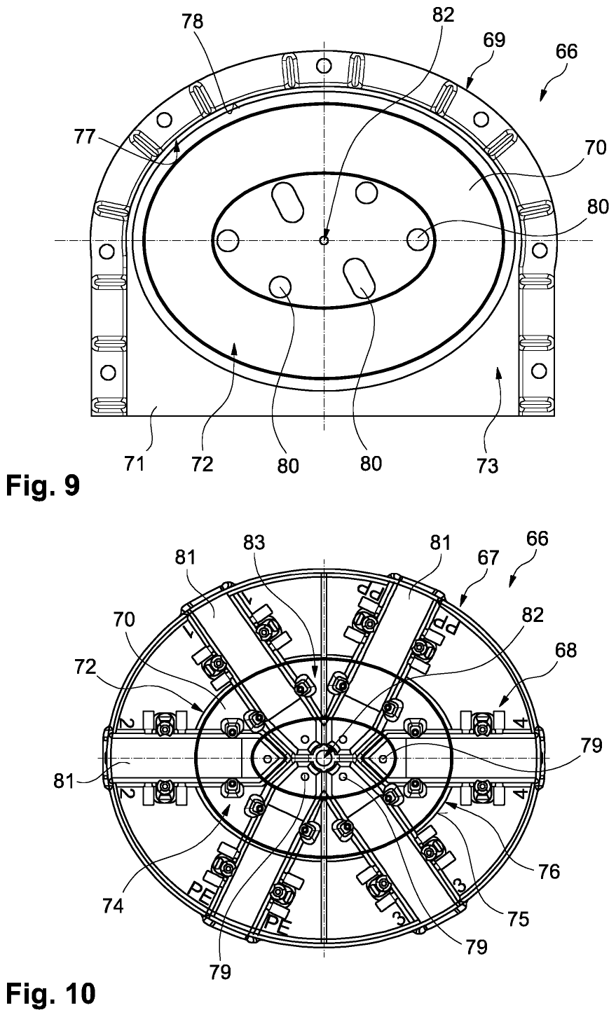

A combination of FIGS. 9 and 10 shows different views of a rapid-charging system 66. A contact device 67 is realized with a positioning unit 68 which allows a movement in the direction of a charging contact device 69 under a vehicle bottom, which is not illustrated in more detail in the case at hand. Contact device 67 has a contact support 70 which can be inserted into a charging contact support 71 of charging contact device 69. Contact support 70 is realized with a projection 72 which can be inserted into opening 73 in charging contact support 71. A contact surface 74 of contact support 70 has a contour 75 in the shape of an ellipse 76. A contact surface 77 of opening 73 has sectionally a contour 78 in the shape of ellipse 76. Contacts 79 are disposed on contact support 70 and charging contacts 80 are disposed on charging contact support 71. Contours 75 and 78 come into contact with each other when contact support 70 is joined with charging contact support 71 in such a manner that contacts 79 are aligned in the correct position relative to charging contacts 80 and a secure formation of contact pairings is ensured. Positioning unit 68 is realized with arms 61 which are disposed in a star-shaped manner and pivotably relative to a central axis 61. Contacts 79 are disposed on respective free ends 83 of arms 81.

1. A rapid-charging system (10, 27, 32, 38, 43, 47, 52, 63, 66) for electrically driven vehicles, the rapid-charging system comprising a contact device (11, 37, 67), a charging contact device (12, 33, 69) and a positioning device (13, 34, 44, 68), the charging contact device being disposable on or in a vehicle bottom (14) of a vehicle and comprising a charging contact support (17, 30, 35, 41, 46, 54, 71) having charging contacts (80), the contact device being disposable on or at least partially in a ground (15) under the vehicle on which the vehicle can drive and comprising a contact support (16, 28, 36, 39, 45, 53, 70) having contacts (79), wherein each contact can establish contact with a charging contact to form a contact pairing, wherein the contact support can be positioned relative to the charging contact support in a contact position by means of the positioning device in such a manner that an electrically conductive connection between the vehicle and a stationary charging station can be realized, wherein the contact support has a projection (18, 31, 42, 51, 55, 72) having the contacts disposed thereon and the charging contact support has an opening (19, 29, 40, 49, 58, 73) having the charging contacts disposed thereon, or vice versa, the projection and the opening having respective contact surfaces (20, 21, 74, 77) of a matching geometric shape, a contour (25, 56, 64, 75) of the projection being oval.

2. The rapid-charging system according to claim 1, wherein in the contact position, the contacts (79) and the charging contacts (80) are disposed in a contact plane (24) parallel relative to the vehicle bottom (14) or the ground (15).

3. The rapid-charging system according to claim 2, wherein the opening (19, 29, 40, 49, 58, 73) and the projection (18, 31, 42, 51, 55, 72) contact each other at least in the contact plane (24) with their respective end faces in the contact position.

4. The rapid-charging system according to claim 2, wherein the opening (19, 29, 40, 49, 58, 73) and the projection (18, 31, 42, 51, 55, 72) form respective matching lateral surfaces (22, 23) inclined relative to the contact plane (24).

5. The rapid-charging system according to claim 1, wherein the contour (25, 56, 64, 75) of the projection (18, 31, 42, 51, 55, 72) is symmetrical.

6. The rapid-charging system according to claim 1, wherein the contour (25, 56, 64, 75) of the projection (18, 31, 42, 51, 55, 72) has the shape of an ellipse (57, 76) or an arc polygon (65).

7. The rapid-charging system according to claim 6, wherein a main axis of the ellipse is transverse to a driving direction of the vehicle.

8. The rapid-charging system according to claim 1, wherein the contour (26, 59, 78) of the opening (19, 29, 40, 49, 58, 73) is open on one side relative to the driving direction of the vehicle.

9. The rapid-charging system according to claim 1, wherein the contact support (16, 28, 36, 39, 45, 53, 70) or the charging contact support (17, 30, 35, 41, 46, 54, 71) has springs each exerting a spring force on contacts (79) or charging contacts (80) in such a manner that the contact or the charging contact in question is pressed in the direction of an opposite contact and/or charging contact.

10. The rapid-charging system according to claim 9, wherein the contacts (79) and the charging contacts (80) are each realized by printed boards, the printed boards being disposed within a surface of a contact support element of the contact support (16, 28, 36, 39, 45, 53, 70) or a charging contact support element of the charging contact support (17, 30, 35, 41, 46, 54, 71), said contact support element being made of a dielectric material.

11. The rapid-charging system according to claim 1, wherein the contact support (16, 28, 36, 39, 45, 53, 70) or the charging contact support (17, 30, 35, 41, 46, 54, 71) is at least sectionally rotatable and/or pivotable relative to a vertical central axis (82) of the rapid-charging system (10, 27, 32, 38, 43, 47, 52, 63, 66).

12. The rapid-charging system according to claim 1, wherein the contact device (11, 37, 67) or the charging contact device (12, 33, 69) has the positioning device (13, 34, 44, 68), the positioning device being realized by at least a pantograph, a pivoted lever, a swing arm or a telescope guide by means of which the contact support (16, 28, 36, 39, 45, 53, 70) or the charging contact support (17, 30, 35, 41, 46, 54, 71) can be positioned in an at least vertical direction.

13. The rapid-charging system according to claim 1, wherein the positioning device (13, 34, 44, 68) is realized by pivotable arms (81) which are disposed in a star-shaped manner relative to a vertical central axis (82) of the rapid-charging system (10, 27, 32, 38, 43, 47, 52, 63, 66) and on whose respective ends (83) is disposed a contact (79) or a charging contact (80).

14. The rapid-charging system according to claim 1, wherein the positioning device (44) is realized by a level control of the vehicle, wherein the charging contact device can be positioned in an at least vertical direction by means of said level control.

15. The rapid-charging system according to claim 1, wherein the contact device (11, 37, 67) or the charging contact device (12, 33, 69) has a protective element having at least one movable plate by means of which an end side of the contacts (79) or the charging contacts (80) can be completely covered.

16. The rapid-charging system according to claim 1, wherein the contact device (11, 37, 67) is realized in such a manner that the vehicle can drive on or over it.

17. The rapid-charging system according to claim 1, wherein the contact device (11, 37, 67) or the charging contact device (12, 33, 69) has a transponder unit, wherein the transponder unit can be coupled with the positioning device and data can be transmitted between the transponder unit and the positioning device (13, 34, 44, 68).

18. A vehicle comprising a rapid-charging system (10, 27, 32, 38, 43, 47, 52, 63, 66) according to claim 1.
